(19) United States
(12) Patent Application Publication
(10) Pub. No.: US 2009/0290485 A1
(43) Pub. Date: Nov. 26, 2009

(54) DISTRIBUTED COMMUNICATION SYSTEM AND CORRESPONDING COMMUNICATION METHOD

(75) Inventors: Manfred Zinke, Aachen (DE); Markus Baumeister, Munich (DE); Peter Fuhrmann, Aachen (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/307,794

(22) PCT Filed: Jul. 9, 2007
(86) PCT No.: PCT/IB2007/052694

§ 371 Date: Jan. 7, 2009

(30) Foreign Application Priority Data
Jul. 19, 2006 (EP) 06117479.3

(51) Int. Cl. H04L 12/26

(52) U.S. Cl. 370/221

(57) ABSTRACT

In order to further develop a communication system (400) as well as a corresponding communication method in such way that a protection of the communication medium (300, 310) from timing failures of a communication controller (120) of a node (100), in particular a limited protection of the communication channel (300, 310) from illegal transmissions in the time domain, can be achieved without providing any bus guardian, it is proposed to prevent any transmission of the node (100) during phases with high susceptibility to illegal transmission, in particular during the communication startup of the communication system (400).

The present invention relates in general to the architecture of communication network systems.

More particularly, the present invention relates to a node, in particular to an electronic control unit, of a distributed communication system with a number of nodes, in particular with at least one fail-silent node, the nodes being interconnected by a communication medium, in particular by at least one channel and by at least one optional further channel, (with this wording covering single-channel systems up to N-channel systems).

The present invention further relates to a method for monitoring communication between and among a number of nodes, in particular between and among at least one unprotected node and at least one fail-silent node, said communication being based on at least one cyclic time-triggered communication medium access schedule being assigned to at least one communication controller.

Dependable communication networks used for safety-critical automotive applications typically rely on time-triggered communication protocols like
TTP/C (=Time-Triggered Protocol Class C; cf. “TTP/C Specification”, version 1.1, edition 1.4.3.19, November 2003, TTTech Computertechnik AG; http://www.tttech.com/) or
FlexRay (cf. “FlexRay Communications System Protocol Specification”, version 2.0, June 2004, FlexRay Consortium; http://www.flexray.com/ or “The FlexRay Protocol”, Electrical & Computer Engineering, Carnegi Mellon; http://www.ece.cmu.edu/˜ece549/lectures/15_flexray.pdf),
   based on broadcast messages according to a predetermined T[ime]D[ivision]M[ultiple]A[ccess] scheme.

Dependable communication is achieved by providing redundant communication channels and protection against illegal transmissions, for example by means of a bus guardian.

More particularly, safety-critical applications require that a single fault in one of the nodes or in the communication infrastructure may not inhibit communication between other fault-free nodes. They rely on using at least two redundant communication channels and on fail-silent behaviour of faulty nodes.

Fail-silent behaviour of faulty nodes can be achieved by means of supervision units like the bus guardian (cf. “FlexRay Communications System Bus Guardian Specification”, version 2.0, June 2004, FlexRay Consortium; http://www.flexray.com/), which protects a communication channel from illegal transmissions in the time domain.

In general, communication networks for safety-critical applications should be separated from other networks but due to cost reasons sometimes there is a demand for using a single network for safety-critical and non-critical applications.

In addition, due to cost reasons sometimes it is not acceptable to use only fail-silent nodes. This results in mixed networks being composed of standard nodes without any protection and fail-silent nodes. The standard nodes in such networks are connected to only one of the communication channels and therefore a single faulty standard node cannot prevent communication between fail-silent nodes being related to the safety-critical application.

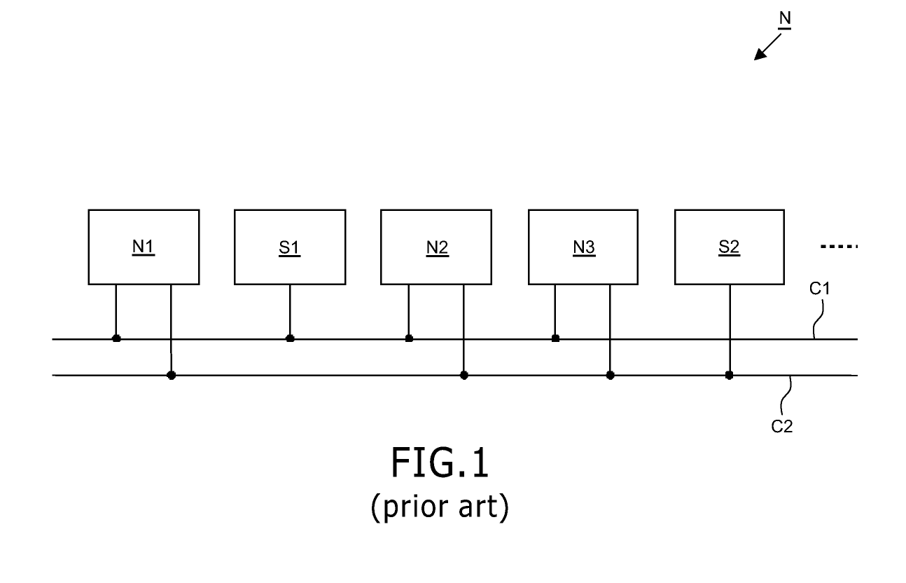

FIG. 1 shows an example of such a mixed network N with bus topology. In this example, the three nodes N1, N2, N3 are related to a safety-critical application. These three nodes N1, N2, N3 are connected to both communication channels C1, C2 and must behave fail-silent. The two further nodes S1, S2 do not belong to a safety-critical application, and for cost reasons these two nodes S1, S2 are implemented as standard nodes not behaving fail-silent.

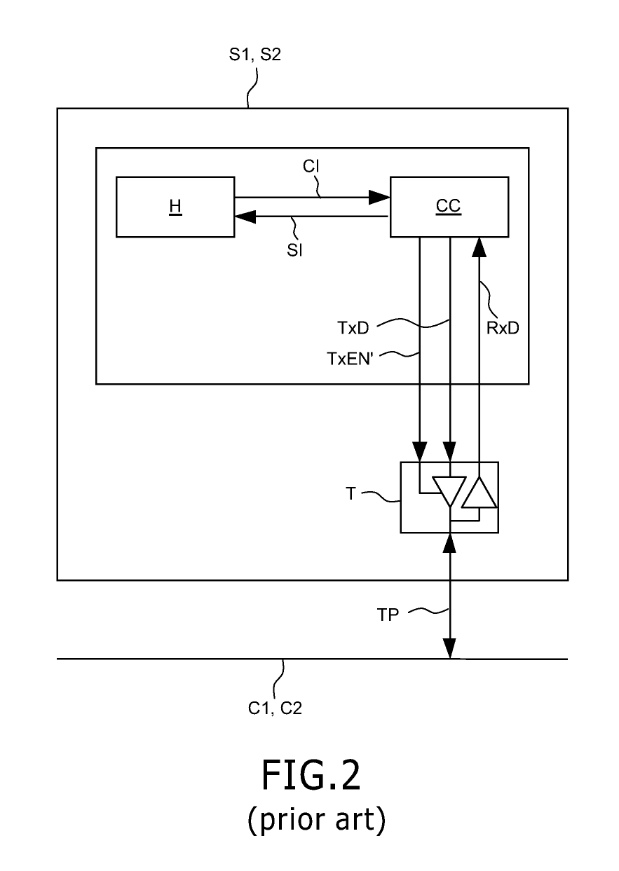

The principal architecture of such standard nodes S1, S2 is shown in FIG. 2. Such standard node S1, S2 comprises
a host H, in particular a host computer or a host controller, running the application,
a communication controller CC implementing the communication protocol, and a transceiver unit T providing the physical interface to the communication network N, in particular
to the first communication channel C1 (in the case of the first standard node S1 being not assigned to a safety-critical application) or
to the second communication channel C2 (in the case of the second standard node S2 being not assigned to a safety-critical application).

It can be further taken from FIG. 2 that the host H and the communication controller CC exchange signals in the form of
configuration and control information CI (from the host H to the communication controller CC), and
status information SI (from the communication controller CC to the host H) (in most implementations, the host controller H and the communication controller CC can be integrated into a single piece of silicon).

The data signals RxD, TxD, TxEN′ being exchanged between the communication controller CC and the transceiver T comprise
received data signals RxD (from the transceiver T to the communication controller CC),
transmission data input signals TxD (from the communication controller CC to the transceiver T), and
transmission enable signals TxEN′ (from the communication controller CC to the transceiver T).

The two standard nodes S1, S2 (as shown in detail in FIG. 2) are connected only to one of the communication channels C1, C2; in more detail,
the first standard node S1 is connected only to the first communication channel C1, and
the second standard node S2 is connected only to the second communication channel C2.

With this approach a single faulty standard node (in FIG. 1 potentially standard node S1 or standard node S2) cannot affect both communication channels (in FIG. 1 the first communication channel C1 and the second communication channel C2), and therefore the requirements of safety-critical applications can be met even though a subset of the nodes does not behave fail-silent.

The startup of such distributed communication network systems typically relies on the exchange of specific messages between a subset of the nodes. If this message exchange is affected by messages from a faulty node then the startup may be inhibited. The following description is based on the startup of a FlexRay cluster but the described disadvantages may apply also to other communication protocols.

In FlexRay systems, the cold start is performed by a predefined subset of the nodes in a communication cluster. Each of these so-called cold start nodes can act
as a leading cold start node initiating the startup of the cluster or
as a following cold start node synchronizing to the schedule established by a leading cold start node.

After wakeup, a cold start node first listens to the communication channel(s) for a listen period. If the cold start node receives a valid pair of startup frames from another cold start node then the cold start node derives its schedule and clock correction from this cold start node. To allow network startup even in case of a cable failure, communication on one communication channel is sufficient for this.

Only if a cold start node does not detect activity on any communication channel during this listen period, the cold start node assumes that the cluster startup has to be initiated and acts as a leading cold start node by sending startup frames.

Integrating nodes, (i. e. non-cold start) nodes must also first listen to the communication channel(s). They may only start transmitting after they have received valid startup frame pairs from at least two cold start nodes. This shall ensure that the startup is not affected by transmissions from integrating nodes. Faulty integrating nodes could start transmitting at any time, including startup.

Such faulty transmissions during startup may be prevented by a bus guardian, if available, but in a mixed network as shown in FIG. 1 only the fail-silent nodes N1, N2, N3 are equipped with a bus guardian. In such a network a faulty standard node S1, S2 could transmit valid messages or invalid messages at any time.

Even though connected only to one communication channel C1 or C2 such a fault could result in frames being received by the cold start nodes during the listen period, thus causing the cold start nodes to assume an already running network. As a result none of the cold start nodes would act as a leading cold start node and thus, the cluster startup would not be initiated.

In the described scenario a single faulty standard node would be able to inhibit the cluster startup completely.

To summarize, mixed networks may contain unprotected nodes related to non-critical applications, as long as these nodes are connected to one communication channel only. A disadvantage of this approach is that without protection by a bus guardian illegal transmissions from such nodes can inhibit the network startup.

Regarding related prior art documents, reference can be made to prior art document JP 02-075046 the purpose of which is to avoid unnecessary communication with inactive nodes by enabling each host to monitor by itself the active states of the nodes.

Prior art document EP 1 355 461 A2 describes the wakeup of FlexRay systems, the startup of FlexRay systems and the protection of FlexRay systems by means of a bus guardian.

Regarding the technological background of the present invention, further reference can be made to
prior art document EP 1 355 461 A2 referring to the wakeup of FlexRay systems, the startup of FlexRay systems and the protection of FlexRay systems by means of a bus guardian;
prior art document JP 05-075668 revealing a kind of handshake method by means of which a receiving system controls the data flow in dependence on the level of its buffers; a control code or a control signal is used to prevent the sending system from sending further data;
prior art document JP 09-130874 describing the selection of one of two possible communication paths (with potentially different communication protocols) by means of a C[entral]P[rocessing]U[nit];
prior art document US 2005/0141565 A1 referring to a method for synchronizing clocks in a distributed communication system, and more particularly referring to multiple aspects of FlexRay systems, for example clock synchronization or bus guardians;
prior art document WO 2004/105326 A2 revealing a special time-triggered communication system and communication method for enabling the synchronized startup of two independent single-channel nodes in a dual-channel communication network.
prior art document “X-by-wire systems and time-triggered protocols”; http://user.it.uu.se/˜annikak/exjobb/TTP_and_xbywire.pdf.

Despite all efforts as described above, the problem remains that bus guardians require a costly data interface to protect the communication medium from timing failures of the communication controller, in particular to protect a communication channel from illegal transmissions in the time domain.

Starting from the disadvantages and shortcomings as described above and taking the prior art as discussed into account, an object of the present invention is to further develop a communication system as described in the technical field as well as a corresponding communication method as described in the technical field in such way that a protection of the communication medium from timing failures of the communication controller, in particular a limited protection of the communication channel from illegal transmissions in the time domain, can be achieved without providing any bus guardian.

The object of the present invention is achieved by a node comprising the features of claim 1 as well as by a method comprising the features of claim 8. Advantageous embodiments and expedient improvements of the present invention are disclosed in the respective dependent claims.

The present invention is principally based on the idea of preventing any transmission of the node during phases with high susceptibility to illegal transmission, in particular during the communication startup of the communication system.

More particularly, the present invention refers to the idea of, based on existing information, providing an additional check for the status of the communication cluster or communication system by a host unit which is independent of the communication controller of the node. As result of this check, transmissions of the node are enabled or are disabled. This check can be performed during startup (so-called startup protection) but also during normal operation or during other critical phases or in other critical situations, like during shutdown of the communication cluster or communication system.

Even more particularly, the present invention is principally based on the idea of an efficient startup protection for communication networks; more particularly, the present invention proposes an efficient means for preventing illegal transmissions from a mixed communication network comprising fail-silent nodes and unprotected standard nodes during startup of this communication network. In this context, the startup is to be protected from faulty nodes without bus guardian.

This may be achieved in that transmissions of the communication node are prevented until a successful communication startup has been detected by the host computer. More particularly, after having initialized the node the host computer
disables any transmission and
checks if the network startup has succeeded.

Only after indications for a successful network startup have been met the host computer enables transmissions by the node. This provides redundancy in such a way that the host and the communication controller of a node both must agree on successful communication startup before transmissions from this node will start.

Unlike prior art document 02-075046, the present invention proposes to prevent illegal communication of a faulty communication node; such illegal communication of a faulty communication node might disturb the communication between further faultless nodes in such way that the startup of the whole communication network would be endangered.

The arrangement according to the present invention as well as the method according to the present invention are applicable to nodes which are not related to safety-critical applications and therefore do not require full protection as it would be provided by a bus guardian.

A possible extension of the present invention can be implemented for supervising the synchronization of a node to the FlexRay cluster also during normal operation, i. e. after the startup has been performed. If synchronization of a node to the FlexRay cluster has degraded to the extent that transmissions from this node can no longer be allowed, the communication controller of this node shall enter the normal passive state. In this state, reception is still ongoing but transmission is not allowed. The conditions for this transition from normal active state to normal passive state are configurable.

An example for such a situation would be that no sync[hronization] frames or startup frames are received by all nodes. In that case all nodes should preferably enter the normal passive state, and one of the cold start nodes should preferably initiate a cold start. A single faulty communication controller which would not enter the normal passive state and would continue transmitting in this situation could prevent the network from performing the startup.

By observing the information about the number of received sync[hronization] frames as well as startup frames and by monitoring the states of the communication controller, the host can advantageously detect if a communication controller does not enter the normal passive state although it should. In this situation, the host can advantageously prevent transmissions from this faulty communication controller.

The present invention further relates to a distributed fault-tolerant and/or time-triggered communication system with at least one node as described above, said node being in particular required for communication startup.

The present invention further relates to a computer program product
being able to be run on at least one computer, in particular on at least one microprocessor, for example on the host unit as described above, and
being programmed in order to execute the method as described above.

According to a preferred embodiment of the present invention, the computer program product can be stored on at least one R[ead]O[nly]M[emory] module, on at least one R[andom]A[ccess]M[emory] module or on at least one flash memory module.

The present invention finally relates to the use of at least one node as described above and/or of at least one distributed communication system as described above and/or of the method as described above and/or of at least one computer program product as described above for ensuring error containment in the time domain of the node, in particular for protecting at least one dual-channel environment from illegal transmission.

The present invention may be implemented in the technical field of semiconductor-connectivity-automotive bus systems, for instance on a C[ontroller]A[rea]N[etwork] platform or on a Flexray platform and/or on the basis of an automotive M[edium]A[ccess]C[ontrol] protocol and/or with reference to chip data transfer; more particularly, the present invention may be implemented in low-cost microcontrollers with integrated FlexRay communication controller for automotive communication systems providing network startup protection as differentiating feature.

As already discussed above, there are several options to embody as well as to improve the teaching of the present invention in an advantageous manner. To this aim, reference is made to the claims respectively dependent on claim 1, on claim 8 and on claim 14; further improvements, features and advantages of the present invention are explained below in more detail with reference to a preferred embodiment by way of example and to the accompanying drawings where

FIG. 1 schematically shows an embodiment of a communication system in the exemplary form of a FlexRay cluster topology according to the prior art;

FIG. 2 schematically shows an embodiment of the architecture of a standard electronic control unit or standard node according to the prior art, said standard electronic control unit or standard node being part of the communication system of FIG. 1;

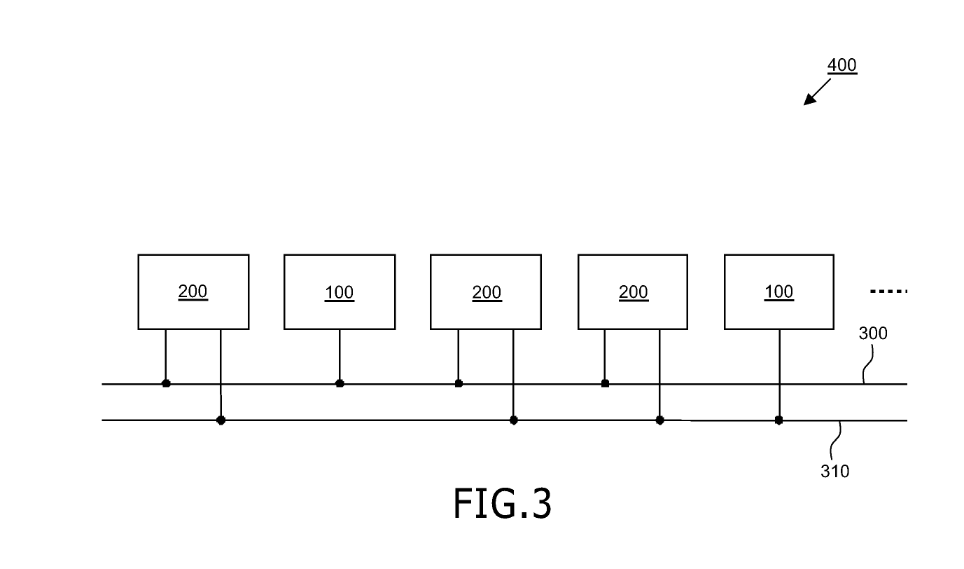

FIG. 3 schematically shows an embodiment of a fault-tolerant time-triggered communication system in the exemplary form of a FlexRay cluster topology according to the present invention, said communication system working according to the method of the present invention;

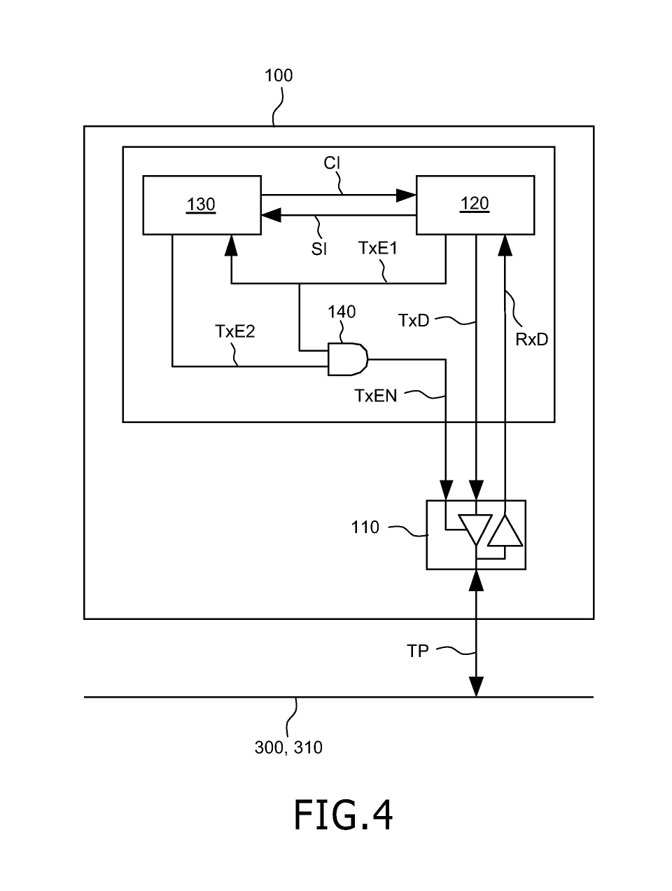

FIG. 4 schematically shows an embodiment of the architecture of an extended standard electronic control unit or extended standard node according to the present invention, said extended standard electronic control unit or extended standard node being part of the fault-tolerant time-triggered communication system of FIG. 3 and working according to the method of the present invention;

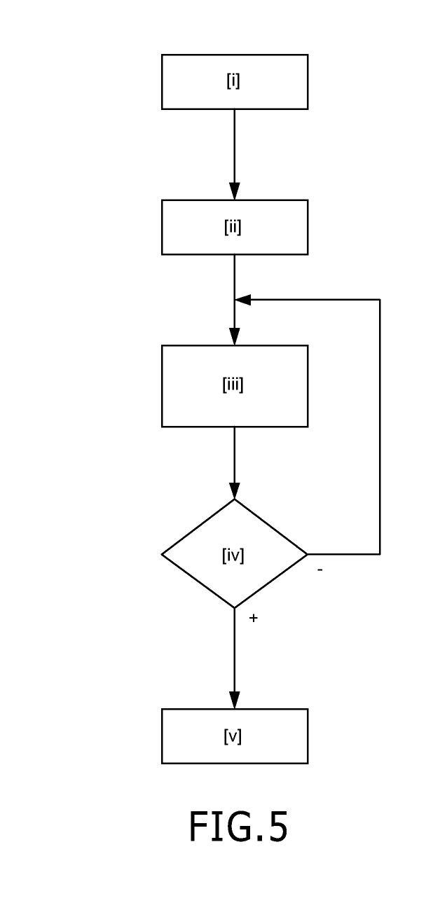

FIG. 5 schematically shows the steps of the method, in particular with reference to the aspect of transmission control, according to which the extended standard electronic control unit or extended standard node of FIG. 4 works; and

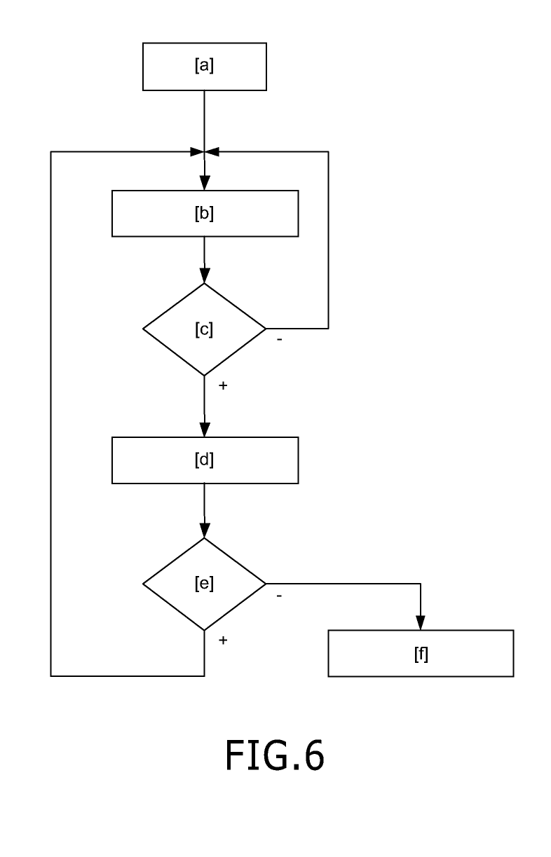

FIG. 6 schematically shows the steps of the method, in particular with reference to the aspect of transmission enabling signal supervision, according to which the extended standard electronic control unit or extended standard node of FIG. 4 works.

The same reference numerals are used for corresponding parts in FIG. 1 to FIG. 6.

The present invention as illustrated in FIGS. 3 to 6 provides a cost-efficient distributed network system (=communication cluster or communication system 400) as well as a method of protecting the communication startup from illegal transmissions of faulty communication nodes within this communication cluster or communication system 400.

By the present invention, the availability of the communication network 400 being composed of a mix of fail-silent nodes 200 and of unprotected extended standard nodes 100 is improved. Other than protection by a bus guardian as in the prior art, the method of the present invention can be applied with standard transceiver circuits not requiring an additional control input for enabling transmission or for disabling transmission.

FIG. 3 shows an embodiment of the mixed network 400 comprising FlexRay cluster topology. In this embodiment, the three nodes 200 are related to a safety-critical application. These three nodes 200 are connected to both communication channels 300, 310 and must behave fail-silent. The two further nodes 100 do not belong to a safety-critical application, and for cost reasons these two nodes 100 are implemented as extended standard nodes not behaving fail-silent.

The principal architecture of such proposed extended standard nodes 100 with startup protection is shown in FIG. 4. Such extended standard node 100 comprises
a host 130, in particular a host computer or a host controller, running the application,
a communication controller 120 implementing the communication protocol and/or providing the status information used by the method of the present invention, and
a transceiver unit 110 providing the physical interface to the communication network 400, in particular
to the first communication channel 300 (in the case of the first standard node 100 being not assigned to a safety-critical application) or
to the second communication channel 310 (in the case of the second standard node 100 being not assigned to a safety-critical application).

It can be further taken from FIG. 4 that the host 130 and the communication controller 120 exchange signals in the form of
configuration and control information CI (from the host 130 to the communication controller 120), and
status information SI (from the communication controller 120 to the host 130) (in many implementations, the host controller 130 and the communication controller 120 can be integrated into a single piece of silicon).

The data signals RxD, TxD, TxEN being exchanged between the communication controller 120 and the transceiver 110 comprise
received data signals RxD (from the transceiver 110 to the communication controller 120), and
transmission data input signals TxD (from the communication controller 120 to the transceiver 110).

As can be taken from FIG. 4, the main functionality of the logical element 140 being implemented as an AND gate is to enable transmission only if both partial enable signals TXE1 (from the communication controller 120) and TXE2 (from the host 130) are activated.

By means of
the AND gate 140 arranged between the transceiver 110, the communication controller 120 and the host 130 as well as
the additional output signal TXE2 between the host 130 and the AND gate 140, the host 130 is able to enable or to disable the transmission path TP.

In addition, in the extended standard node 100 the host 130
can supervise the activation of the transmit enable signal TXE1 from the communication controller 120 and
thereby can detect that the communication controller 120 tries to transmit even though the host 130 has disabled transmission (based on status information provided by the communication controller 120 via the signal SI); this includes transmissions during startup.

In other words, the host 130 monitors whether the communication controller 120 tries to transmit, for example during startup, and the host 130 controls propagation of the transmit enable signal TXE1 from the communication controller 120 to the transceiver 110.

Accordingly, the transmit enable signal TXE1 is controlled by the communication controller 120, not by the host 130 but by means of the additional output signal TXE2 and of the AND gate 140 the host 130 controls the propagation of the transmit enable signal TXE1 from the communication controller 120 to the transceiver 110.

Furthermore, in the extended standard node 100, the host 130 uses the status information SI provided by the communication controller 120 in order to decide if the startup of the FlexRay cluster 400 has been finished, i. e. is completed and if the transmission of the local communication controller 120 can be enabled.

The actual transmission enable signal TxEN is sent from the AND gate 140 to the transceiver 110 as result
of the transmit enable signal TXE1 between the communication controller 120 and the AND gate 140, and
of the additional output signal TXE2 between the host 130 and the AND gate 140.

The two extended standard nodes 100 (as shown in detail in FIG. 4) are connected only to one of the communication channels 300, 310; in more detail,
the first extended standard node 100 is connected only to the first communication channel 300, and
the second extended standard node 100 is connected only to the second communication channel 310.

FIG. 5 shows the corresponding flow diagram of the method steps of the present invention with respect to the transmission control, i. e. with regard to the checking of the status information SI as well as with regard to the disabling of the transmission and/or to the enabling of the transmission:

After the init (=step [i] in FIG. 5), the transmission is disabled (=step [ii] in FIG. 5); status information SI is fetched (=step [iii] in FIG. 5) from the communication controller 120 to the host 130; in case the startup is incomplete, i. e. not finished (=reference numeral “−” after step [iv] in FIG. 5), the procedure goes before the fetch of the status information SI (=step [iii] in FIG. 5) by a loop back path; in case the startup is complete, i. e. finished (=reference numeral “+” after step [iv] in FIG. 5), the transmission is enabled (=step [v] in FIG. 5).

In order to possibly disable transmission again after step [v] continuous supervision of the status information SI from the communication controller 120 can be provided, thus allowing to enable and to disable transmission at any time, in order to provide protection also during normal operation (in addition to startup).

FIG. 6 shows the flow diagram of the method steps of the present invention with respect to the supervision of the transmission enable signal TxEN from the AND gate 140 to the transceiver 110, in particular of the first partial transmission data enable signal TxE1 between the communication controller 120, the host unit 130 and the AND gate 140:

After the init (=step [a] in FIG. 6), a check for transition (=step [b] in FIG. 6) of the transmission enable signal TxE1 from the communication controller 120 is made; in case the transmission enable signal TxE1 is not active (=reference numeral “−” after step [c] in FIG. 6), the procedure goes by a loop back path before the check for transition (=step [b] in FIG. 6) of the transmission enable signal TxE1 from the communication controller 120; in case the transmission enable signal TxE1 is active (=reference numeral “+” after step [c] in FIG. 6), a check (=step [d] in FIG. 6) of the transmission enable signal TxE2 from the host 130 is made; in case the transmission is enabled (=reference numeral “+” after step [e] in FIG. 6), the procedure goes by a loop back path before the check for transition (=step [b] in FIG. 6) of the transmission enable signal TxE1 from the communication controller 120; in case the transmission is not enabled (=reference numeral “−” after step [e] in FIG. 6), an error is indicated (=step [f] in FIG. 6); such error indication can be used for diagnosis purposes.

The process as described in FIG. 5 runs at the host 130 and transmits the second partial transmission data enable signal TxE2 (=additional output signal) between the host 130 and the AND gate 140. The host 130 checks the status information SI provided by the communication controller 120. This status information SI determines if transmission is allowed or not.

Finally, this status information SI can be provided from the communication controller 120 to the host 130 with different levels of independence:

[1] The communication controller 120 reports to the host 130 a communication controller-internal state indicating that the startup has been finished, i. e. has been completed.

This approach relies on some functionality inside the communication controller 120, even in case of a fault.

[2] The communication controller 120 provides to the host 130 the number of cold start nodes 200 from which valid startup frame pairs have been received, and the host 130 checks if valid startup frame pairs from at least the minimum number of cold start nodes 200 have been received.

The communication protocol defines the minimum number of cold start nodes 200 from which startup frame pairs must have been received before a node 100, 200 is allowed to transmit.

[3] For each received frame the communication controller 120 provides to the host 130 the frame header at least containing a frame ID[entification number], a cycle ID[entification number], and an indication for startup frames.

By means of this information, which can be protected by at least one C[yclic]R[edundancy]C[heck] sum, the host 130 can independently check if valid startup frame pairs from at least the minimum number of cold start nodes 200 have been received.

In this context, the host 130 requires this CRC checksum in order to check if the received frame header is valid; otherwise a single bit error, for instance at the communication medium or inside the communication controller 120, could for example change a non-startup frame into a startup frame, thus making the independent check at the host 130 more or less worthless.

The CRC checksum is generated and added to the header by the sending node and cannot be generated by the receiving node. The C[yclic]R[edundancy]C[heck] is to be calculated for all header information provided to the host 130, or at least to the subset of header information to be protected.

By means of the CRC checksum, the communication controller 120 and the host 130 at the receiving node can perform independent validity checks.

With this latter embodiment [3], the maximum independence between a faulty communication controller 120 and the host 130 can be achieved.

[4] Combinations of [1] to [3], for example the host 130 determines the number of received startup frame pairs from different cold start nodes 200 and uses this information to validate the state reported by the communication controller 120.

In all cases [1], [2], [3], [4], the host 130 enables transmission by activating the additional output signal TXE2 between the host 130 and the AND gate 140 only if a condition is met indicating that a node 100 may start transmitting without disturbing the startup.

This condition must be chosen such that in the fault-free case the host 130 enables transmission not later than at the beginning of the first communication cycle, which is used by the communication controller 120 for transmission.

To summarize, the present invention protects the network 400 from illegal transmissions which can disturb protocol mechanisms like communication startup, performed by other nodes 100, 200. These nodes 100, 200 required for communication startup can be fail-silent (=reference numeral 200) but do not necessarily have to be (=reference numeral 100).

### LIST OF REFERENCE NUMERALS

100 extended standard node not assigned to a safety-critical application
110 bus driver, in particular transceiver unit, of extended standard node 100
120 communication controller of extended standard node 100
130 host unit, in particular host computer or host controller, of extended standard node 100
140 logical element, in particular AND gate, of extended standard node 100
200 node assigned to a safety-critical application or cold start node
300 first part of communication medium, in particular first communication channel
310 second part of communication medium, in particular second communication channel
400 mixed communication network or communication system, comprising extended standard node 100 as well as node 200 assigned to a safety-critical application
C1 first part of communication medium, in particular first communication channel (=prior art embodiment; cf. FIGS. 1, 2)
C2 second part of communication medium, in particular second communication channel (=prior art embodiment; cf. FIGS. 1, 2)
CC communication controller implementing communication protocol (=prior art embodiment; cf. FIG. 2)
CI configuration and control information from host unit to communication controller
H host unit, in particular host computer or host controller (=prior art embodiment; cf. FIG. 2)
N mixed communication network with bus topology, in particular in form of a FlexRay cluster (=prior art embodiment; cf. FIG. 1)
N1 first node assigned to a safety-critical application (=prior art embodiment; cf. FIG. 1)
N2 second node assigned to a safety-critical application (=prior art embodiment; cf. FIG. 1)
N3 third node assigned to a safety-critical application (=prior art embodiment; cf. FIG. 1)
RxD receive data output signal from bus driver to communication controller
S1 first standard node not assigned to a safety-critical application (=prior art embodiment; cf. FIGS. 1, 2)
S2 second standard node not assigned to a safety-critical application (=prior art embodiment; cf. FIGS. 1, 2)
SI status data or status information from communication controller to host unit
T bus driver, in particular transceiver unit, providing physical interface to communication network N, in particular to first communication channel C1 or to second communication channel C2 (=prior art embodiment; cf. FIG. 2)
TxD transmit data input signal from communication controller to bus driver
TxE1 first partial transmit data enable signal between communication controller 120, host unit 130 and logical element 140
TxE2 second partial transmit data enable signal, in particular additional output signal, between host unit 130 and logical element 140
TxEN transmit data enable signal from logical element 140 to bus driver 110
TxEN′ transmit data enable signal from communication controller CC to bus driver T (=prior art embodiment; cf. FIG. 2)
TP transmission path between bus driver and communication channel(s)

1. A node, in particular an electronic control unit, of a distributed communication system with a number of nodes, in particular with at least one fail-silent node, the nodes being interconnected by a communication medium, in particular by at least one channel and by at least one optional further channel, characterized by
preventing any transmission of the node during phases with high susceptibility to illegal transmission, in particular during the communication startup of the communication system.

2. The node according to claim 1, characterized
by at least one check, in particular by at least one additional check, for the status of the communication system, the check being provided by at least one host unit of the node, the host unit being independent of at least one communication controller of the node, and
by enabling or by disabling any transmission of the node as result of the check, in particular by preventing any transmission of the node until a startup of the communication of the communication system has been detected.

3. The node according to claim 1, characterized by at least one bus driver, in particular by at least one transceiver unit,
being connected
to the communication controller, as well as
to the communication medium,
being controlled, in particular being enabled and disabled, by at least one logical element, in particular by at least one AND gate,
being provided
with at least one transmit data input signal being transmitted from the communication controller, as well as
with at least one transmit data enable signal being transmitted from the logical element, and
being designed for
transmitting and receiving via the communication medium, as well as
transmitting at least one receive data output signal to the communication controller,
wherein the host unit
is connected
to the bus driver by means of the logical element, as well as
to the communication controller, and
is designed for
receiving at least one status information (SI) from the communication controller, as well as
transferring at least one configuration and control information to the communication controller.

4. The node according to claim 3, characterized by
at least one power supply unit, in particular at least one battery, connected with ground and with the bus driver, and/or
at least one voltage regulator connected with, in particular multiple voltage regulators respectively connected with one or more of,
the power supply unit,
the bus driver,
the communication controllers, and/or
the host unit.

5. The node according to claim 1, characterized in that the logical element enables any transmission of the node only if
at least one first partial transmit data enable signal from the communication controller as well as
at least one second partial transmit data enable signal, in particular at least one additional output signal, from the host unit are activated.

6. The node according to claim 1, characterized by the logical element being arranged between the bus driver, the communication controller and the host unit in such way that the host unit
can supervise the activation of the first partial transmit data enable signal from the communication controller,
can transmit the second partial transmit data enable signal to the logical element, and
can detect if the communication controller tries to transmit even though the host unit has disabled transmission based on the status information from the communication controller, in particular if the communication controller tries to transmit during startup.

7. (canceled)

8. A method for monitoring communication between and among a number of nodes, in particular between and among at least one unprotected node and at least one fail-silent node, said communication being based on at least one cyclic time-triggered communication medium access schedule being assigned to at least one communication controller,
characterized by
preventing any transmission of the unprotected node during phases with high susceptibility to illegal transmission, in particular during the communication startup of the communication system.

9. The method according to claim 8, characterized by
by at least one status check, in particular by at least one additional status check, the status check being provided by at least one host unit, the host unit being independent of the communication controller, and
by enabling or by disabling any transmission of the unprotected node as result of the check, in particular by preventing any transmission of the unprotected node until a startup of the communication has been detected.

10. The method according to claim 8,
characterized by controlling the transmission by disabling the transmission and by enabling the transmission, in particular by
[i] initiating;
[ii] disabling the transmission;
[iii] fetching status information from the communication controller to at least one host unit;
[iv] determining whether the startup of the communication of the communication system is not finished or is finished:
in case of the startup of the communication of the communication system being not finished, then again fetching the status information;
in case of the startup of the communication of the communication system being finished, then
[v] enabling the transmission.

11. The method according to claim 8, characterized by continuous supervision of the status information from the communication controller, allowing to enable and to disable transmission of the unprotected node at any time, in particular in order to provide protection during normal operation or during at least one critical phase or in at least one critical situation, like during startup of the communication system or during shutdown of the communication system.

12. The method according to claim 8, characterized by supervising at least one first partial transmit data enable signal being transmitted from the communication controller, in particular by
[a] initiating;
[b] checking for transition of at least one first partial transmit data enable signal from the communication controller;
[c] determining whether the first partial transmit data enable signal is not active or is active:
in case of the first partial transmit data enable signal being not active, then going back before checking for transition of the first partial transmit data enable signal from the communication controller;
in case of the first partial transmit data enable signal being active, then
[d] checking the status information provided by the communication controller, said status information determining if any transmission of the unprotected node is allowed or not;
[e] determining whether the transmission is enabled or is not enabled:
in case of the transmission being enabled, then going back before checking for transition of the first partial transmit data enable signal from the communication controller;
in case of the transmission being not enabled, then
[f] indicating at least one error.

13. The method according to claim 8, characterized in that the status information is provided from the communication controller to the host unit with different levels of independence, in particular
that the communication controller reports to the host unit at least one internal state of the communication controller indicating that the startup has been finished, and/or
that the communication controller provides to the host unit the number of received valid startup frame pairs from different nodes, and that the host unit checks if valid startup frame pairs from at least one minimum number of cold start nodes have been received,
that for each received frame the communication controller provides to the host unit the frame header at least containing
at least one frame ID[entification number],
at least one cycle ID[entification number], and/or
at least one indication for startup frames, and/or
that at least one checksum, in particular at least one C[yclic]R[edundancy]C[heck] sum, is generated and added to at least one subset of the header of the respective startup frame, with said checksum allowing the host unit to check the correctness and/or the validity of the header of the respective startup frame.

14-16. (canceled)
